(19) United States
(12) Patent Application Publication
(10) Pub. No.: US 2010/0230970 A1
(43) Pub. Date: Sep. 16, 2010

(54) Green Energy

(76) Inventor: Manouchehr Barcohen, Santa Monica, CA (US)

Correspondence Address: Manouchehr Barcohen, 101 California Ave. # 1004, Santa Monica, CA, 90403-3523, US

(21) Appl. No.: 12/381,656

(22) Filed: Mar. 16, 2009

(51) Int. Cl. F03B 13/06

(52) U.S. Cl. 290/54

(57) ABSTRACT

A tanker with underneath revolving wheels, loaded with water and generators installed on its top, while it rolls on rails on a sloping runway, creates kinetic energy. Cross shafts, connected to the centers of turning wheels, interlock lower differential gears, which through vertical connective shafts, engage upper differential gears and cause upper cross shafts turn and activate generators. Generated electricity will be transmitted by generators' connective devices to receiving circuits. After power production, water in the tanker must be emptied before the tanker be pushed to the pond to sail towards ascending rails. By raising the level of water in this section of the canal by using a divider, a towing truck can pull out the raised empty tanker onto the ground through ascending rails, place it in the loading area to be loaded with water, then pushed onto descending rails to resume electricity production.

### BACKGROUND OF THE INVENTION

My invention regarding the production of electricity through kinetic energy, originates from the theory of Mr. Davoud Navi who had devised putting to use different elements, sources and devices to create “Green Energy”. He believed that he had come up with an invention and had fulfilled his theory.

On that account, a few months ago, Mr. Navi came to my residence and signed the declaration of his invention in my presence and asked me to certify that, which I did.

He explained that running a tow-boat, loaded with water on a sloping runway, towing several generators, set on rail on an adjacent wall alongside the runway, results in producing kinetic energy that could be converted to electricity. Mr. Navi had not prepared any drawings nor had he specified how the towed generators produced electricity or how the power would be transmitted to other circuits. He said that by having a river next to a facility and two ponds, one at the top and the other at the bottom of a runway and a canal between the ponds, after unloading the tow-boat, it could be pulled out from the canal and returned to the top of the runway, by raising, in several phases, the level of water in the respective sections of the canal. I asked him: “How you bring back the generators?” He said: “By transferring them, on rail, to the top of the tow-boat and place them back on the wall.” To me that process seemed to be very difficult, arduous and time consuming.

Later on, after pondering about his invention, I discovered that Mr. Navi, apparently, had failed to envision the submerged part of the boat, which called for the creation of a passage-way for the boat, to either come out from the canal or go back to the runway, which would ultimately resulted in having the same level of water at the top and the bottom of the runway; thus, eliminating the possibility of producing kinetic energy.

### BRIEF SUMMARY OF THE INVENTION

Having in mind the idea of Mr. Navi, regarding the river, the runway, the boat, the ponds and particularly the canal; I realized that having a pond eliminates the need to have a river alongside the facility, as an absolute necessity, even though it was and is economically preferable; because the pond could and can be a source of water, both, to fill up the boat or to raise the level of water in a particular section of the canal to raise the boat.

For the reason that Mr. Navi's invention was not achievable, as I have mentioned in the “Background of Invention”, I submit to you that after a lot of contemplations, I concluded that installing the generators, permanently, on the top of a tanker would obliterate the need for a wall and the very difficult task of transferring the generators to the top of the tanker in order to bring them back to be transferred, again, to the top of the wall, as required by his plan. Further, by eliminating the upper pond, devising descending rails to the pond and ascending rails to the ground and by employing differential gears, cross and vertical shafts and other devices, that will be described in details, by means of drawings, I have come up with the invention to produce electricity through kinetic energy, which is practical, very economical and a great contribution to bring about “Green Energy”.

### BRIEF DESCRIPTION OF THE DRAWINGS

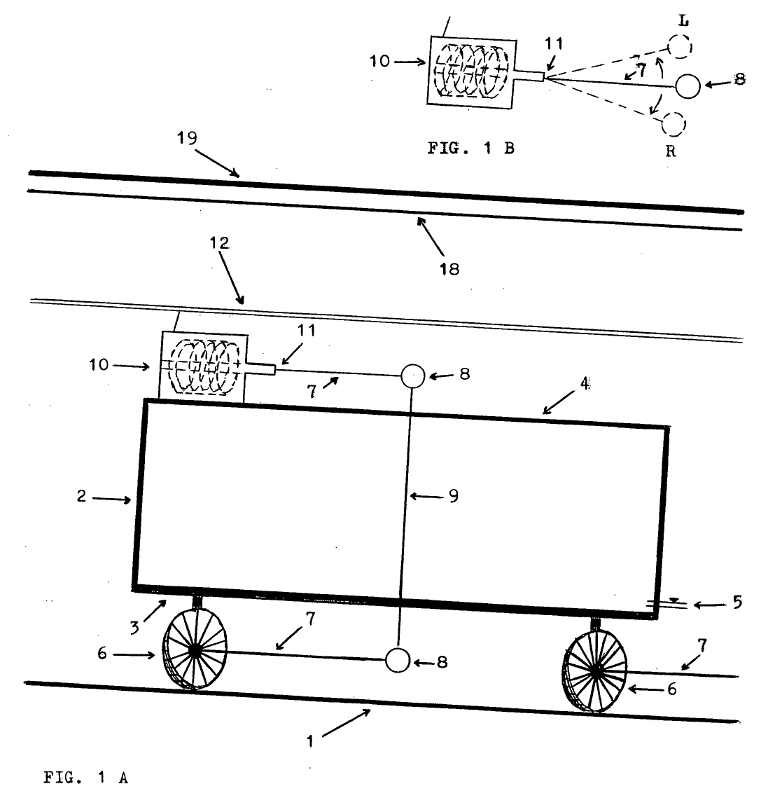

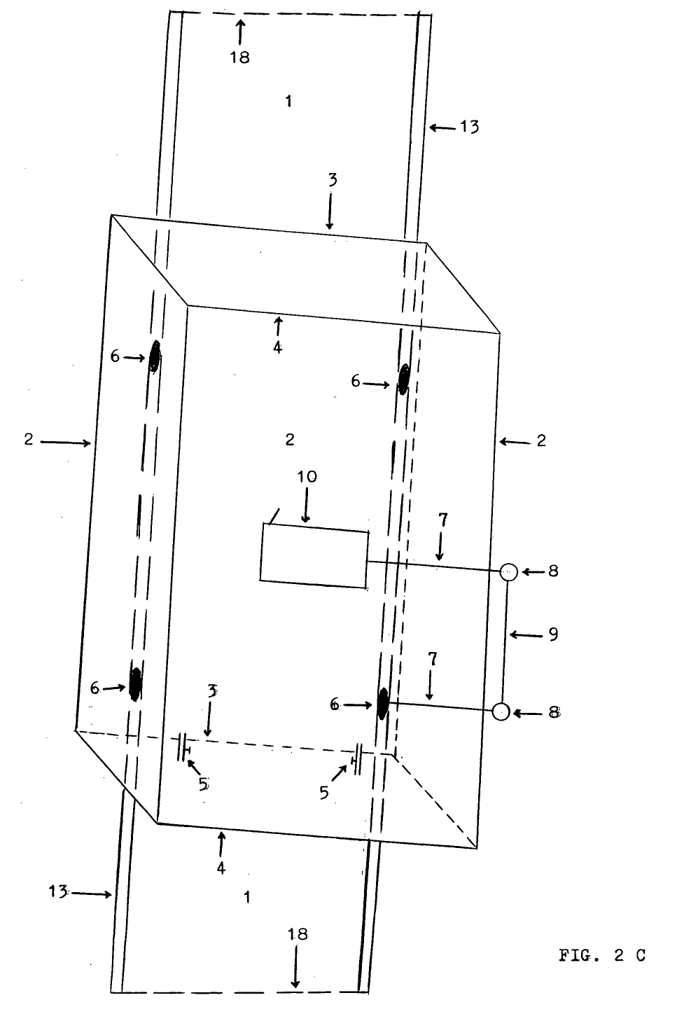

There are eight drawings for this invention. Figures could not be drawn proportionally. Drawings illustrate only the concept, means and devices used in the process to accomplish the goal of the invention. In absence of an actual photo of the tanker and devices attached to it (which does not exist yet), FIGS. 1A, 1B & 2C are complements to each other to demonstrate the directions of all characters (e.g., cross and vertical shafts, differential gears and generator) which could not be drawn in completion, on one single FIGURE.

Drawing 1/8: Demonstrates the runway (1), wheels (6) under the tanker (2) and generator with its transmitting device (10) on the tanker's top (4) connected to the conductor (12) under the ceiling (18), roof (19), tanker's bottom (3), shut-off valve (5), cross shaft (7) from the wheel to differential gear (8), vertical connective shaft (9) to upper differential gear and therefrom cross shaft to the generator. this upper cross shaft is capable of turning left or right through a vertical axis (11), as a cautionary measure, to allow the upper differential gear and the vertical connective shaft to adjust themselves to the turning of the wheels. (Shown in smaller figure.) (FIGS. 1A & 1B)

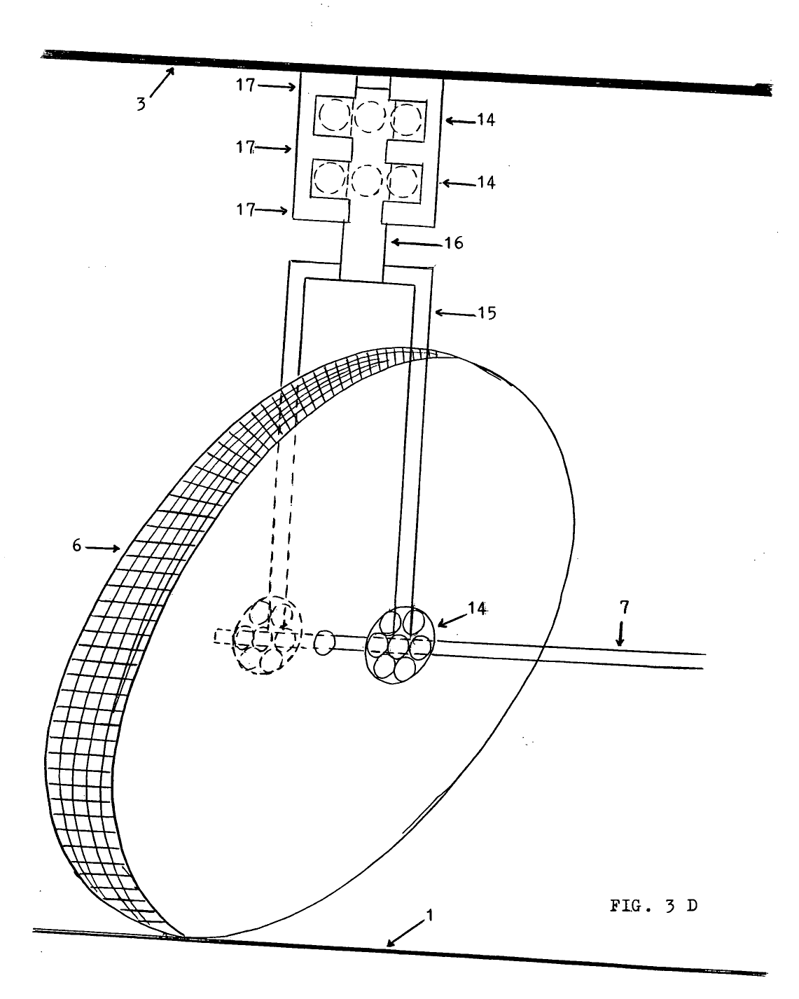

Drawing 2/8: Shows the runway (1), the ceiling (18) over the tanker (2) on rails (13), tanker's bottom (3) and its top (4). Wheels (6) under the tanker and generator (10) on its top. Lower and upper cross shafts (7), lower and upper differential gears (8). vertical connective shaft (9) and valves (5) at the bottom of the tanker. (FIG. 2C)

Drawing 3/8: Depicts wheel (6) on the runway (1), ball bearings in their housings (14) on the two sides of the wheel, connected to the wheel's turning tongs (15) which is conjoint with a revolvable wheel's vertical shaft (16). this shaft is in the center of two sets of ball bearings inside their housing which is attached to the bottom of the tanker (3) and the teeth (17) inside the housing protruding into the grooves around the wheel's vertical shaft to prevent the top of the shaft to touch the bottom of the tanker. Cross shaft (7) connected to the wheel, surrounded by ball bearings in housings that are connected to the wheels' tongs. Mechanical engineers might choose other designs for wheels.

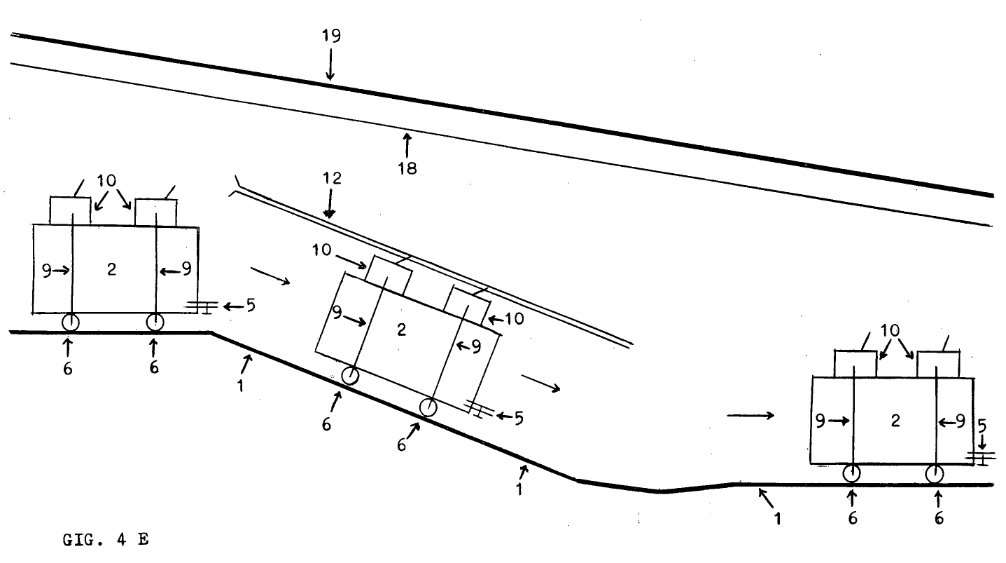

Drawing 4/8: Displays the runway (1), the tanker (2) on wheels (6) in different areas of the runway, connective vertical shafts (9), generators with their connective devices (10) to the conductor (12) (rail or grooved cable), set on the wall, to transmit electricity to other circuits, shut-off valves (5), ceiling (18) and roof (19). (FIG. 4E)

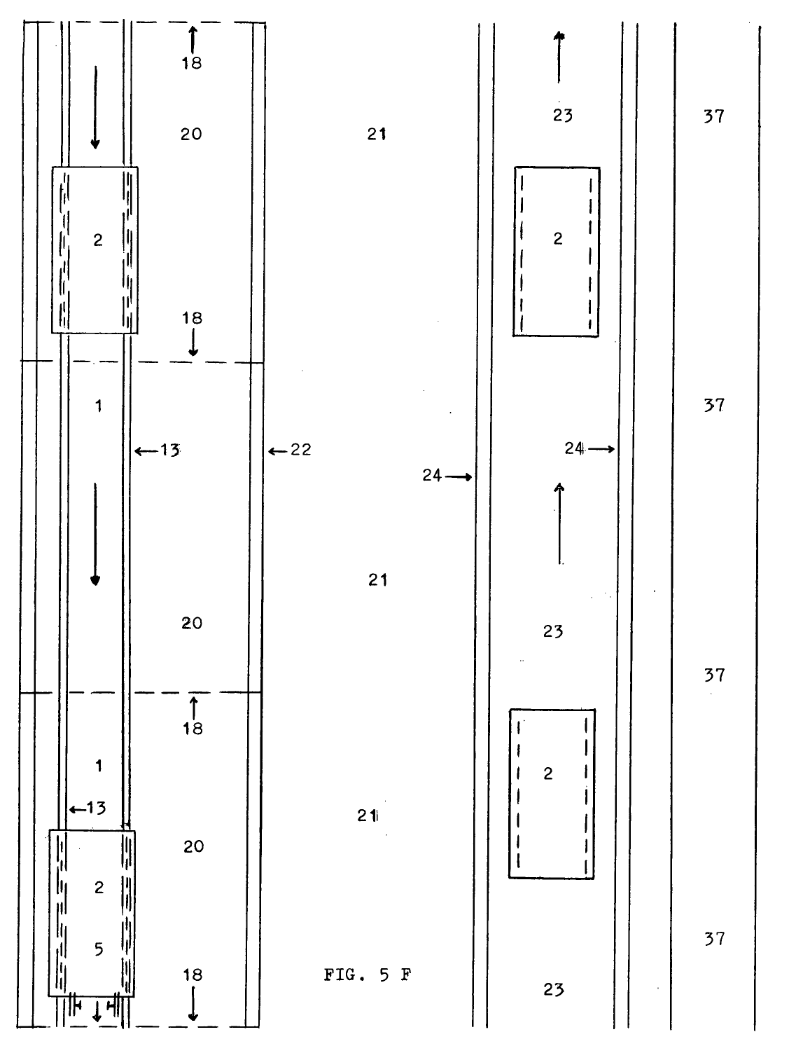

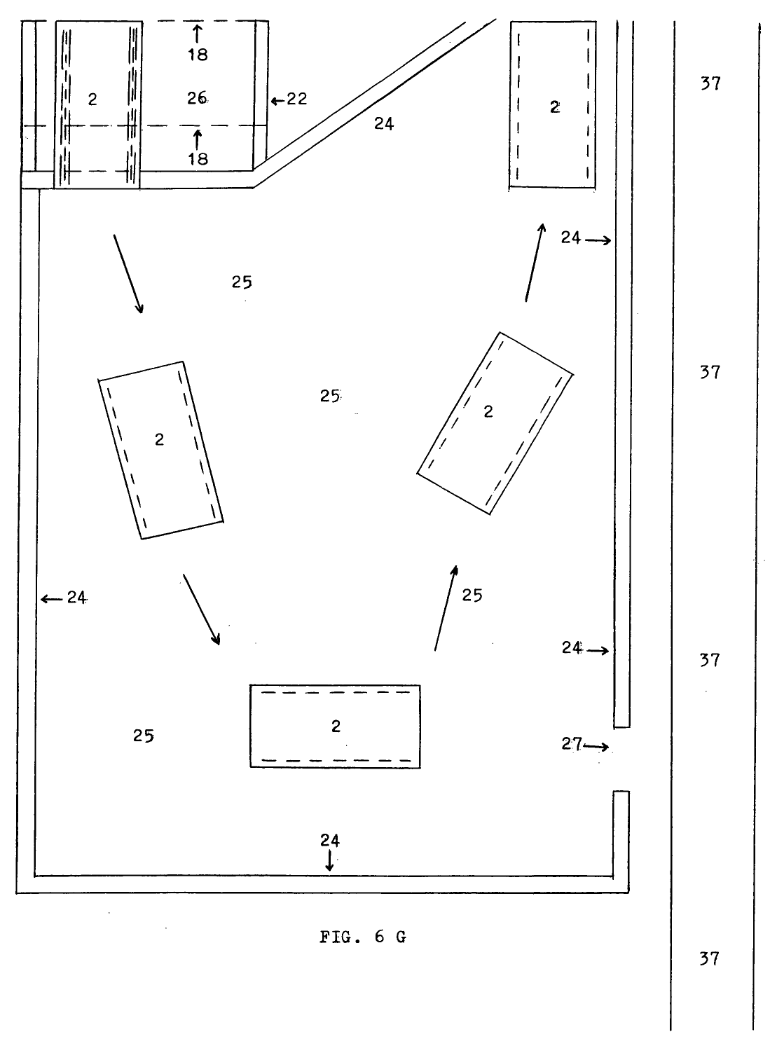

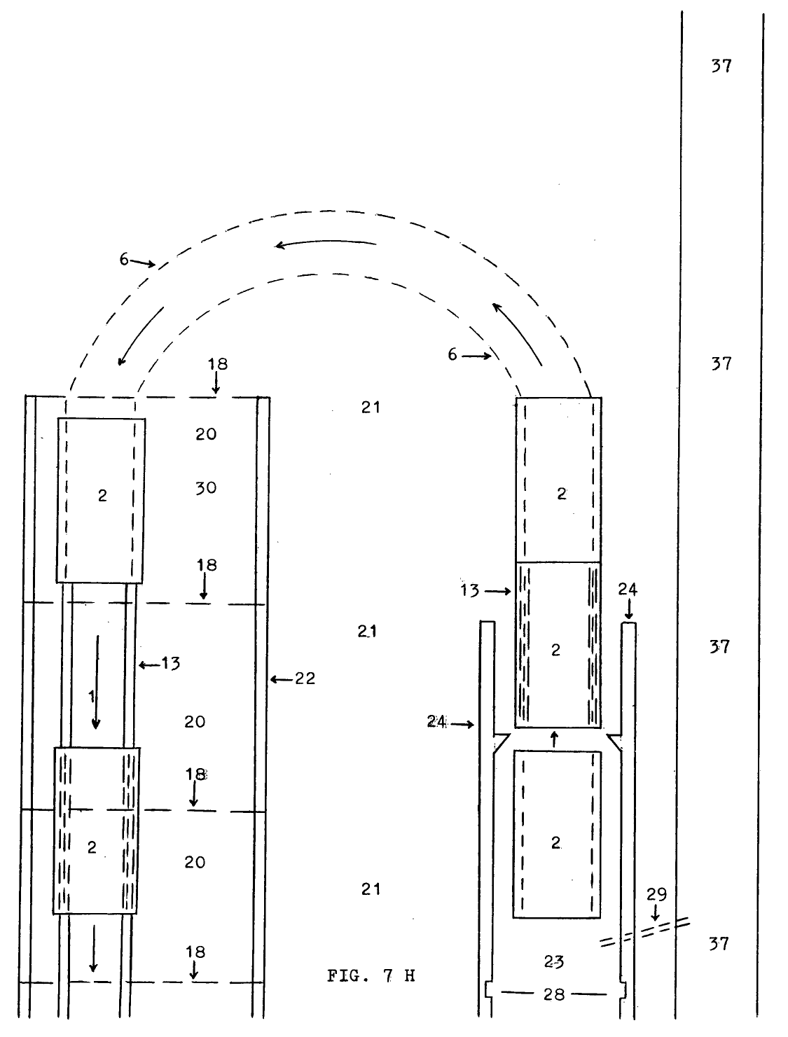

Drawing 5/8: Depicts the ceiling (18) over the track (20), tanker (2) on descending rails (13) in the runway (1) and tanker close to the pond (5) (shown in FIG. 6G). Walls (22) alongside the track, ground (21), canal (23) and concrete walls (24). Tanker just entered the canal and tanker close to the ascending rails (13) (shown in FIG. 7H). (FIG. 5F)

Drawing 6/8: Shows the pond (25), the tanker (2) on descending rails (13) to the pond, flanked by steep areas (26) between the walls (22) surrounding the steep areas under the ceiling (18), concrete walls (24) around the pond, tanker in different positions moving towards the canal (23) (shown in FIG. 5F). Passageway (27) to allow the superfluous water in the pond to flow back to the lower part of the river, if there is one alongside the facility as the source of water. (FIG. 6G)

Drawing 7/8: Demonstrates rails (13), the tanker (2) in loading area (30) and on the descending rails on the runway (1), all under ceiling (18), walls (22) alongside the loading area and the track (20), canal (23) and grooves (28) in its concrete walls (24), pipe (29) from the river (if available), tanker at the narrowed end of the canal (passed the grooves), tanker on ascending rails and on the ground (21). (FIG. 7H)

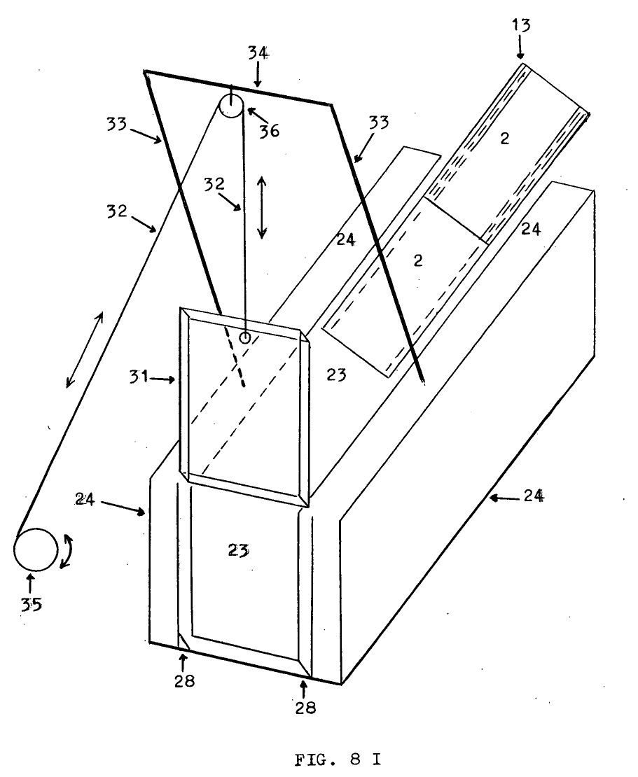

Drawing 8/8: Displays the canal (23) and grooves (28) cut in the concrete walls (24) and the bottom of the canal, tanker (2) passed the grooves and tanker on the ascending rails (13), divider (31) hung by cable (32) aligned with the grooves in the concrete walls of the canal, columns (33) and holding bar (34) for the divider, pulley (35) and sheave (36) to lower or raise the divider by means of cable. (FIG. 8 I)

### DETAILED DESCRIPTION OF THE INVENTION

To generate electricity without using fossil fuel and bring about “Green Energy”, we need to create kinetic energy and convert it to electricity. The followings show what elements, sources and devices are needed to achieve this goal:
1—A long sloping runway, about one mile, on a track, with two parallel lines of rails on concrete slab, along the track under a ceiling all the way through. (FIGS. 1A, 2C, 4E & 5F)
2—A tanker loaded with water, with two parallel rows of underneath revolving wheels, as small as possible, two create optimum R.P.M. (FIGS. 1A, 2C & 4E)
3—A source of water, which could be a river alongside the facility (preferable, but not an absolute necessity), a pond or a lake (natural or man-made) at the lower end of the track. (FIG. 6G)
4—A canal connected to the pond or lake, preferably parallel to the runway and equally deep as the man-made pond. (FIGS. 5F, 7H & 8 I)
5—Generators installed on the top of the tanker. (FIGS. 1A, 2C & 4E)
6—Differential gears. (FIGS. 1A & 2C)
7—Connective vertical shafts between lower and upper differential gears. (FIGS. 1A, 2C & 4E)
8—Cross shafts from the wheels under the tanker to lower differential gears and from upper differential gears to generators. (FIGS. 1A, 1B & 3D)
9—Conductor(s) for transmittal of electricity to other circuits. (FIGS. 1A & 4E)

The process: While the loaded tanker rolls on wheels on the concrete slab on the sloping runway, it gathers speed, resulting in creation of kinetic energy, which through the devices mentioned earlier activate the generators and produce electricity. (FIGS. 1A, 2C & 4E) To prevent the tanker not to thrust into the pond, the grade of the slope of the runway must be modified, after production of power, then slightly reversed to uphill position and finally becomes level near the end of the runway to cause the tanker to stop close to the pond; (FIG. 4E) and then pushed forward by a truck or tractor to the starting point of the descending rails to the pond. (FIG. 6G) At this time, shut-off valves of the tanker shall be opened to empty the loaded water into the pond, (FIG. 5F) then the unloaded tanker will be pushed onto the descending rails to the pond. (FIG. 6G) When the tanker enters the pond, it moves towards the canal by engaging its engine and propeller(s). (FIG. 6G) After the tanker enters the canal, it sails forward to the narrowed end of the canal, at the edge of the ascending rails to be guided thereon. (FIG. 7H)

To raise the tanker in this part of the canal (passed the grooves), the level of water must be raised to a point high enough to place the wheels under the tanker at level surface with the rails on the concrete slab under the lower edge of the ascending rails. (FIG. 7H) This level of water depends on the slope of the ascending rails, which must be determined by taking into account the measure of the submerged part of the tanker.

To raise the level of water in the same part of the canal, the flow of water to the pond, through the canal, must be cut off by sliding down the divider, hung by cable from the holding bar, to the bottom of the canal. The divider must be aligned with water-tight grooves cut in the concrete walls of the canal, behind the tanker. (FIGS. 7H & 8 I) When the level of water puts the tanker in the right position, the flow of water from the river or pumping of water from the pond must be stopped. then a towing truck or tractor can pull the tanker out from the canal, through ascending rails, onto the ground to be directed, on its revolving wheels, towards the loading area to be filled up with water, by pump, from the river or the pond; before entering the runway. (FIG. 7H) To avoid splash of water on the generators, if water is supplied by river, the pipe must beset so slant to end close to the bottom of the canal. (FIG. 7H) Likewise, if water is being pumped from the pond, the hose must be extended close to the bottom of the canal.

### Notes:

1—Loading area, track and the runway must be under ceiling to avoid electrical hazards in rainy days, while generators produce electricity. Tanker(s) must be equipped with retractable covers or other mechanical devices to cover and protect the generators outside the runway, in rains and storms. In such weathers, generators must be covered before the tanker enters the pond, until it is stationed in the loading area.
2—Number of generators should be equal to the number of wheels. Generators must be installed side by side, in two rows, so that all wheels of the tanker activate all generators and produce maximum electricity.
3—Considering that generators on the top of the tanker are not stationary during the production of power, electricity generated by them should be transmitted to other circuits through a conductor (rail or a grooved cable etc.), meticulously insulated and precisely set parallel to the runway, preferably under the ceiling of the track, along the moving tanker, up to the point that generators produce power. Electrical engineers may prefer other ways or means for the transmittal of electricity. Choice is theirs.
4—The bottom of the tanker should be as flat as possible to allow the tanker to be equipped with smaller wheels to bring about optimum R.P.M.
5—Two or more tankers must be used on each runway, at calculated and computerized intervals of times, to ensure continuity of power production.
6—Two or more runways and canals are recommended in each facility to prevent eventual power black-outs, in case a problem arises in one of the runways, canals or devices employed in the process. Besides, they can generate more electricity under exceptional circumstances.
7—To establish a facility, architects, engineers (civil, electrical, mechanical etc.), manufacturers, executives of power plants and city or county officials must collaborate and coordinate their efforts and plans to successfully achieve their goal.
8—This invention will have an impact on coal industries. Some employees and coal miners, eventually, will lose their jobs. But, in return, additional jobs will be created, nationwide, for manufacturing of tankers, generators, rails, devices and construction of facilities necessary to produce energy.

1. I believe that my invention is a practical solution to obviate the use of fossil fuel for the purpose of creating electrical power. Thus, the constant importation of oil from OPEC and other oil exporting countries will be reduced significantly.
Also, it is economically feasible, because after expending the initial costs to establish power plants, no major expenses will remain to run those facilities to generate electricity. Such power plants can bring about kinetic energy, again and again, with minimal expenditures. Comparing the expenses to run these power plants to the volumes of their electricity outputs, indicates that the low costs of energy production, will result in substantial fall of the price of electricity for the consumers. For example. on a one mile track, if electrical power is produced in one kilometer of the runway, a tanker with a gross weight of 1,000 (one thousand) tons, at the speed of 27 kilometers per hour, will generate 3,750,000 (three million seven hundred and fifty thousand) KWH in that distance (one kilometer) according to
$$E = \frac{1}{2} M \times {V}^{2} ,$$
which amounts to 90,000,000 (ninety million) kilowatts in 24 hours, enough to provide power for more than 2,000,000 (two million) households of 3 or 4 members, excluding plants and factories. Executives of power plants, in each city or county, are to decide about the size and the capacity of the power plant(s) they deem it suitable for the region.
This invention contributes to reduce air pollution, as a result of obliterating the use of fossil fuel for production of power and, consequently, it will be a big step towards “Green. Energy”. It also eliminates the need for nuclear energy to create electricity, which makes a lot of people jittery if their State be chosen the site for a nuclear reactor.
